(19) United States
(12) Patent Application Publication
(10) Pub. No.: US 2014/0367419 A1
(43) Pub. Date: Dec. 18, 2014

(54) FOAM CARTRIDGES, PUMPS, REFILL UNITS AND FOAM DISPENSERS UTILIZING THE SAME

(71) Applicants: Donald R. Harris, Tallmadge, OH (US); Aaron D. Marshall, Cuyahoga Falls, OH (US); John J. McNulty, Broadview Heights, OH (US); Nick E. Ciavarella, Seven Hills, OH (US)

(72) Inventors: Donald R. Harris, Tallmadge, OH (US); Aaron D. Marshall, Cuyahoga Falls, OH (US); John J. McNulty, Broadview Heights, OH (US); Nick E. Ciavarella, Seven Hills, OH (US)

(73) Assignee: GOJO INDUSTRIES, INC., Akron, OH (US)

(21) Appl. No.: 14/304,469

(22) Filed: Jun. 13, 2014

Related U.S. Application Data
(60) Provisional application No. 61/835,273, filed on Jun. 14, 2013.

(51) Int. Cl. A47K 5/14; B67D 7/74

(52) U.S. Cl. CPC A47K 5/14; B67D 7/74
USPC 222/190; 222/135; 222/145.5; 222/255; 222/325

(57) ABSTRACT

Exemplary embodiments of foam cartridges, refill units for foam dispensers, and foam dispensers are disclosed herein. An exemplary foam cartridge for a foam pump that may be used in a refill unit includes a housing. The housing includes an upper cylindrical portion and a lower cylindrical portion. One or more air passageways are located through the upper cylindrical portion. The foam cartridge includes an interior cylindrical member having a dome. The interior cylindrical member is located at least partially within the upper cylindrical portion of the housing. One or more mixing passages located between the interior cylindrical member and the upper cylindrical portion of the housing, and one or more mix media are located at least partially within the lower cylindrical portion of the housing.

### RELATED APPLICATIONS

This application claims priority to and the benefits of U.S. Provisional Patent Application Ser. No. 61/835,273 filed on Jun. 14, 2013 and entitled “Foam Cartridges, Pumps, Refill Units And Foam Dispensers Utilizing The Same,” which is incorporated herein by reference in its entirety.

### TECHNICAL FIELD

The present invention relates generally to pumps, refill units for foam dispensers and foam dispensers, and more particularly to foam pumps, refill units and foam dispensers having a foam cartridge.

### BACKGROUND OF THE INVENTION

Liquid dispenser systems, such as liquid soap and sanitizer dispensers, provide a user with a predetermined amount of liquid upon actuation of the dispenser. In addition, it is sometimes desirable to dispense the liquid in the form of foam by, for example, injecting air into the liquid to create a foamy mixture of liquid and air bubbles. As a general matter, it is usually preferable to reduce the space taken up by the pumping and foaming apparatus within the overall dispenser system. This maximizes the available space for storing the liquid, and has other benefits. In addition, it is desirable to have a foam pump that requires less energy to operate. Some liquids, such as, for example, alcohol based liquids are difficult to foam and require enhanced mixing.

### SUMMARY

Exemplary embodiments of foam cartridges, refill units for foam dispensers, and foam dispensers are disclosed herein. An exemplary foam cartridge for a foam pump that may be used in a refill unit includes a housing. The housing includes an upper cylindrical portion and a lower cylindrical portion. One or more air passageways are located through the upper cylindrical portion. The foam cartridge includes an interior cylindrical member having a dome. The interior cylindrical member is located at least partially within the upper cylindrical portion of the housing. One or more mixing passages located between the interior cylindrical member and the upper cylindrical portion of the housing, and one or more mix media are located at least partially within the lower cylindrical portion of the housing.

An exemplary refill unit includes a container containing a foamable liquid, a liquid pump in fluid communication with the container and an air inlet for receiving pressurized air. A foam cartridge is located downstream of the liquid pump and in fluid communication with the air inlet. The foam cartridge has a cylindrical outer housing and a cylindrical interior member. The cylindrical interior member has a closed upper portion. One or more liquid inlets located proximate the closed upper portion to allow liquid to flow around the cylindrical interior member. A mixing passage is located between the cylindrical outer housing and the cylindrical interior member. In addition, one or more air passages are located through the cylindrical outer housing into the mixing passage.

Another exemplary refill unit includes a container of foamable liquid, an outlet nozzle, a liquid pump having a liquid outlet and an air inlet for receiving pressurized air. A foam cartridge. The foam cartridge has a cylindrical outer housing and a cylindrical interior member. A mixing passage is located at least partially between the cylindrical outer housing and the cylindrical interior member. An air chamber is located about the exterior of the cylindrical outer housing. One or more air passages extend through the cylindrical outer housing to the mixing passage between the cylindrical outer housing and the cylindrical interior member. Liquid and air meet in the mixing passage. The mixing passage opens to a mixing area having a cross-sectional area that is greater than the cross-sectional area of the mixing passage.

### BRIEF DESCRIPTION OF THE DRAWINGS

These and other features and advantages of the present invention will become better understood with regard to the following description and accompanying drawings in which:

FIG. 1 is a cross-section of an exemplary foam dispenser having a refill unit;

FIG. 2 is a cross-section of an exemplary refill unit;

FIG. 3 is a cross-section of another exemplary refill unit;

FIG. 4 is a cross-section of a lower pump housing with an exemplary foaming cartridge;

FIG. 5 is a prospective view of the exemplary foaming cartridge of FIG. 4; and

FIG. 6 is a plan view of the exemplary foaming cartridge of FIG. 4.

### DETAILED DESCRIPTION

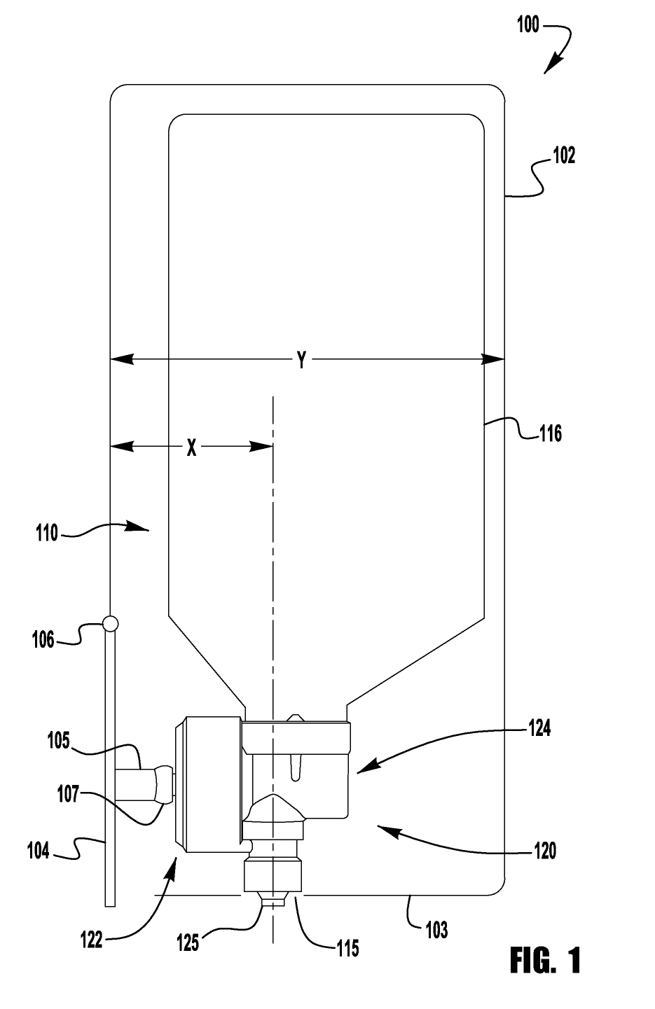

FIG. 1 illustrates an exemplary embodiment of a foam dispenser 100. The cross-section of FIG. 1 is taken through the housing 102 to show the foam pump 120 and container 116. Foam dispenser 100 includes a disposable refill unit 110. The disposable refill unit 110 includes a container 116 connected to a foam pump 120. The foam dispenser 100 may be a wall-mounted system, a counter-mounted system, an un-mounted portable system movable from place to place or any other kind of foam dispenser system.

The container 116 forms a liquid reservoir that contains a supply of a foamable liquid within the disposable refill unit 110. In various embodiments, the contained liquid could be for example a soap, a sanitizer, a cleanser, a disinfectant or some other foamable liquid. In the exemplary disposable refill unit 110, the container 116 is a collapsible container and can be made of thin plastic or a flexible bag-like material. In other embodiments, the container 116 may be formed by a rigid housing member, or have any other suitable configuration for containing the foamable liquid without leaking The container 116 may advantageously be refillable, replaceable or both refillable and replaceable. In other embodiments, the container 116 may be neither refillable nor replaceable.

In the event the liquid stored in the container 116 of the installed disposable refill unit 110 runs out, or the installed refill unit 110 otherwise has a failure, the installed refill unit 110 may be removed from the foam dispenser 100. The empty or failed disposable refill unit 110 may then be replaced with a new disposable refill unit 110.

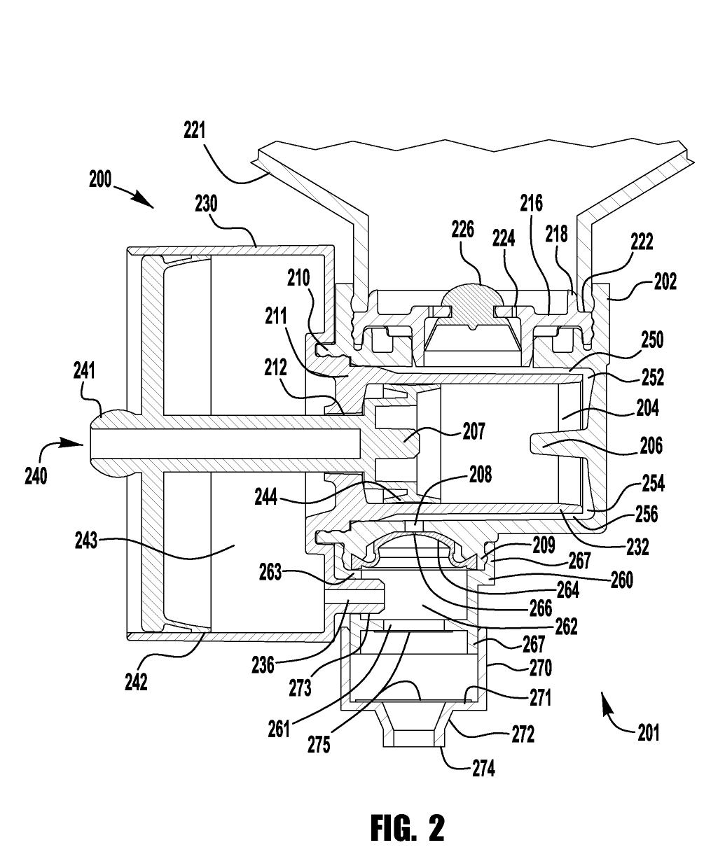

The housing 102 of the foam dispenser 100 contains one or more actuating members 104 to activate the pump 120. As used herein, actuator or actuating members or mechanism includes one or more parts that cause the dispenser 100 to move liquid, air or foam. Actuator 104 is generically illustrated because there are many different kinds of pump actuators which may be employed in the foam dispenser 100. The actuator of the foam dispenser 100 may be any type of actuator such as, for example, a manual lever, a manual pull bar, a manual push bar, a manual rotatable crank, an electrically activated actuator or other means for actuating the foam pump 120 which includes a liquid pump portion 124 and air compressor portion 122. Electronic actuators may additionally include a sensor to provide for a hands-free dispenser system with touchless operation. In one embodiment, actuator 104 is connected to housing 102 by a hinge member 106. Various intermediate linkages, such as for example linkage 105, connect the actuator member 104 to the foam pump 120 within the system housing 102. In one embodiment, linkage 105 has a socket 107 that snaps onto a ball 241 (FIG. 2) at the proximate end of piston 240. An aperture 115 in bottom plate 103 of housing 102 allows foam dispensed from the nozzle 125 of foam pump 120 to be dispensed to a user.

As described in more detail below, one advantage of the exemplary embodiments of the present invention is that the outlet of the foam pump 120 may be offset from the liquid inlet. Thus, a more compact housing 102 may be used. In one embodiment the distance X from the front of the housing 102 to the centerline of the outlet nozzle 125 is between about 1.25 and 2.5 inches. In one embodiment, the distance X is between about 1.5 and 2 inches, and in one embodiment the distance is about 1.7 inches from the front of the housing. In one embodiment, the overall depth Y of housing 102 is less than about 5 inches, and in another embodiment the overall depth Y is about 4 inches.

FIG. 2 is a cross-sectional view of an exemplary embodiment of a refill unit 200 suitable for use in foam dispensers. Refill unit 200 includes a container 221 for holding a foamable liquid connected to a foam pump 201. Liquid pump 201 includes a housing 202. Housing 202 receives inlet plate 216. Inlet plate 216 includes an annular projection 218. A neck of a container 221 is received within an annular groove 222 formed between annular projection 218 and housing 202. Housing 202 may be connected to the container 221 by any means such as, for example, a threaded connection, a welded connection, an adhesive connection or the like. Optionally, a gasket may fit in annular groove 222 to help form a liquid tight seal with the container 221. Inlet plate 216 may be integrally formed with housing 202.

Inlet plate 216 includes one or more inlet apertures 224 located therethrough. In addition, one-way inlet valve 226 is secured to inlet plate 216. One-way inlet valve 226 may be any type of one-way valve such as, for example, a ball and spring valve, a poppet valve, a flapper valve, an umbrella valve, a slit valve, a mushroom valve, a duck bill valve or the like.

Pump housing 202 includes a liquid chamber 204. In one embodiment liquid chamber 204 is cylindrical. Located at least partially within liquid chamber 204 is a sleeve 232. Housing 202 includes an annular projection 210 at one end of the liquid chamber 204. Sleeve 232 is secured to annular projecting member 210 by collar 211. Collar 211 includes an aperture 212.

A piston 240 includes a shaft 241 that projects through aperture 212. Piston 240 is slideable in a reciprocating manner within sleeve 232. Piston 240 includes a piston head having a double wiper seal 244 located at the distal end. Movement of piston 240 causes the volume of liquid chamber 204 to expand and contract. Double wiper seal 244 may be any type of sealing member such as, for example, an o-ring, a single wiper seal or the like. Housing 202 includes a projecting member 206 that contacts an end 207 of piston 240 to stop movement of piston 240 when it reaches the end of its stroke.

In addition, piston 240 includes a second piston head and sealing member 242 located at the proximal end of piston 240. Second sealing member 242 engages the inside of the air compressor housing 230. The term “air compressor” may be used interchangeably herein with the term “air pump.” In one embodiment, air compressor housing 230 and sleeve 232 are formed as one piece. Movement of piston 240 causes air chamber 243 to expand and contract. Air chamber 243 includes an air outlet 236, which is also an air inlet to mixing chamber 262. In one embodiment, air outlet 236 is integrally formed with both sleeve 232 and air compressor housing 230.

A liquid inlet passageway 250 is formed between sleeve 232 and the wall of liquid chamber 204. The liquid inlet passageway 250 may extend entirely around sleeve 232 or may be enclosed by one or more rib projections (not shown) that cause liquid in inlet passageway 250 to flow through passage 250 and passage 252 into the interior of sleeve 232. Outlet passages 254, 256 also exist between sleeve 232 and the walls of liquid chamber 204. Outlet passageway 256 may extend entirely around sleeve 232 or may be enclosed by one or more rib projections (not shown) that cause liquid to flow from the interior of sleeve 232 through passageways 254, 256. Passageway 254 and passageway 250 may be connected to form a common passageway.

Housing 202 includes an outlet passage 208. Connected to housing 202 is lower housing 260. Lower housing 260 may be connected to housing 202 by any means such as, for example, a threaded connection, a snap-fit connection, a welded connection an adhesive connection or the like. In the present exemplary embodiment, lower housing 260 includes annular projection 267 that snaps onto annular projection 209 of housing 202. Located proximate outlet passage 208 is a liquid outlet valve 264. Liquid outlet valve 264 includes a slit 266. Slit 266 opens to allow liquid to flow from liquid chamber 204 into mixing chamber 262. The backing provided by the wall surrounding the liquid outlet 208 prevents the slit 266 from opening when there is pressure in mixing chamber 262 and prevents liquid and/or air from entering liquid chamber 204 from mixing chamber 262. Liquid outlet valve 264 is retained in place by annular rim 263 on lower housing member 260. While a slit valve is shown and advantageously takes up very little room, other types of liquid outlet valves may be used such as, for example, a ball and spring valve, a flapper valve, a poppet valve, a mushroom valve, a duck-bill valve or the like.

Lower housing 260 has an interior cavity that forms a mixing chamber 262. Lower housing 260 includes an opening 273 in the wall of mixing chamber 262. The air outlet 236 of air chamber 243 is fitted into opening 273 to allow mixing chamber 262 to be in fluid communication with air chamber 243. Mixing chamber 262 is in fluid communication with liquid chamber 204 through valve 264. In addition, lower housing 260 includes an outlet opening 261 and a lower annular projection 267. Outlet nozzle 270 fits over lower projection 267 to secure outlet nozzle 270 to lower housing 260. Outlet nozzle 270 is secured using a press-fit connection, but may be connected by other means such as, for example, a snap-fit connection, an adhesive, a threaded connection or the like. Outlet nozzle 270 includes a floor 271, a tapered portion 272 and an outlet 274. In addition, a foaming media 275, such as one or more screens, is included in outlet nozzle 270. Optionally, a foaming cartridge may be used whereby the foaming cartridge rests on floor 271. In some embodiments, screens 275 are replaced by one or more porous members or baffles.

An exemplary benefit to using sleeve 232 is that the liquid inlets 224, or liquid inlet valve 226 may be positioned over any portion of the sleeve 232 without affecting the volume of liquid chamber 204 or reducing the efficiency of pump 201. Similarly, the liquid outlet 208 and/or liquid outlet valve 264 may be located along any portion of the sleeve 232 without reducing the volume of liquid chamber 204 or reducing the efficiency of pump 201. In some embodiments, the liquid inlet and the liquid outlet are off-set from one another. In some embodiments the liquid outlet is located closer to the front of a dispenser than the liquid inlet when the pump 201 is installed in the foam dispenser. In some embodiments, the liquid inlet and liquid outlet are along a common axis. The piston 240 may move along a pump axis that is substantially horizontal. In some embodiments, the liquid inlet valve 226 moves along an axis that is substantially normal to the pump axis. In some embodiments, at least a portion of the liquid inlet valve 226 moves along a substantially vertical axis even though it may collapse both horizontally and vertically.

In addition, although the pump 201 has been described as being made of selected sub-parts, pump 201, as well as the other embodiments of pumps disclosed herein, may be made from more sub-parts or fewer sub-parts.

During operation, as piston 240 of pump 201 moves from a discharged position to a charged position or primed state, liquid flows in through liquid inlets 224, past one-way inlet valve 226, into liquid chamber 204, through passages 250, 252 and into the interior of sleeve 232, which also forms a portion of the liquid chamber 204.

Movement of piston 240 from the charged position to the discharged position causes fluid to flow out of the liquid chamber 204 (including the center of the sleeve 232) through passages 254, 256, past liquid outlet valve 264 and into mixing chamber 262. Simultaneously, the volume of air chamber 243 is reduced and air flows out of air outlet 236 into mixing chamber 262. The air and liquid mixture is forced through opening 261 and through foam media 275 to create a rich foam. The rich foam travels through tapered section 272 where it accelerates due to the reduced volume and exits foam pump 201 through outlet 274.

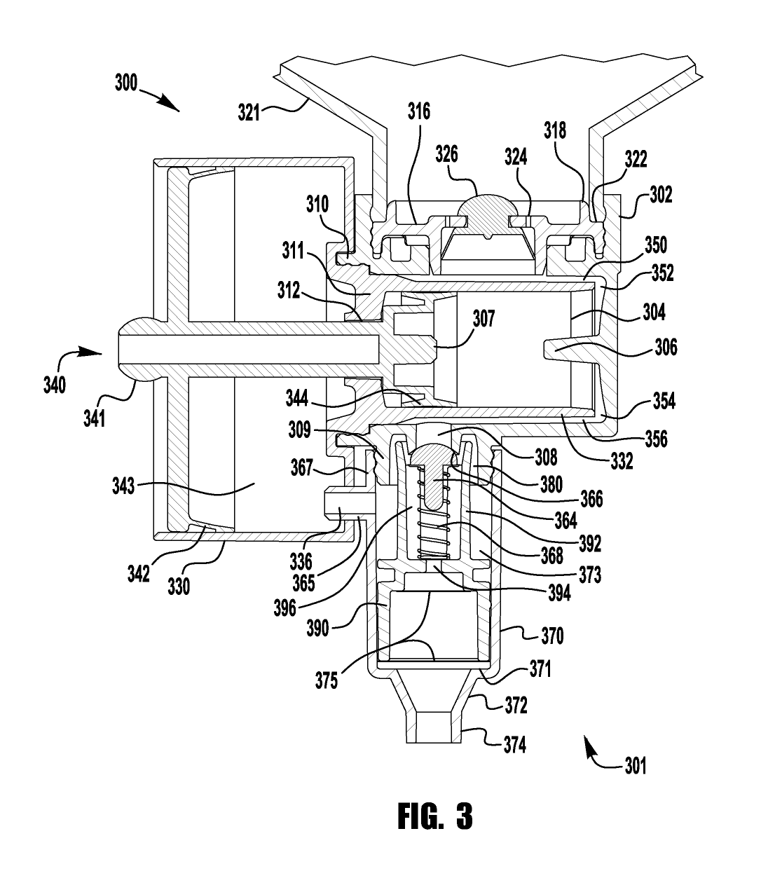

FIG. 3 is a cross-sectional view of another exemplary embodiment of a refill unit 300 suitable for use in foam dispensers. Refill unit 300 includes a container 321 for holding a foamable liquid connected to a liquid pump 301. Liquid pump 301 includes a housing 302. Housing 302 receives inlet plate 316. Inlet plate 316 includes a annular projection 318. A neck of a container 321 is received within an annular groove 322 formed between annular projection 318 and housing 302. Housing 302 may be connected to the container 321 by any means such as, for example, a threaded connection, a welded connection, an adhesive connection or the like. Optionally a gasket may fit in annular groove 322 to help form a liquid tight seal with the container. Inlet plate 316 may be integrally formed with housing 302. Inlet plate 316 includes one or more inlet apertures 324 located therethrough. In addition one-way inlet valve 326 is secured to inlet plate 316. One-way inlet valve 326 may be any type of one-way valve such as, for example, a ball and spring, a poppet valve, a flapper valve, an umbrella valve, a slit valve, a mushroom valve, a duck-bill valve or the like.

Pump housing 302 includes a liquid chamber 304. In one embodiment liquid chamber 304 is cylindrical. Located at least partially within liquid chamber 304 is a sleeve 332. Housing 302 includes an annular projection 310 at one end of the liquid chamber 304. Sleeve 332 is secured to annular projecting member 310 by collar 311. Collar 311 includes an aperture 312.

A piston 340 includes a shaft 341 that projects through aperture 312. Piston 340 is slideable in a reciprocating manner within sleeve 332. Piston 340 includes a piston head having a double wiper seal 344 located at the distal end. Movement of piston 340 causes the volume of liquid chamber 304 to expand and contract. Double wiper seal 344 may be any type of sealing member such as, for example, an o-ring, a single wiper seal or the like. Housing 302 includes a projecting member 306 that contacts an end 307 of piston 340 to stop movement of piston 340 when it reaches the end of its stroke.

In addition, piston 340 includes a second piston head and sealing member 342 located at the proximal end. Second sealing member 342 engages the inside of the air compressor housing 330. The term “air compressor” may be used interchangeably herein with the term “air pump.” In one embodiment, air compressor housing 330 and sleeve 332 are formed as one piece. Movement of piston head 342 expands and contracts air chamber 343. Air chamber 343 includes an air outlet 336, which is also an air inlet to mixing chamber 396. In one embodiment, air outlet 336 is integrally formed with both sleeve 332 and air compressor housing 330.

A liquid inlet passageway 350 is formed between sleeve 332 and the wall of liquid chamber 304. The inlet passageway 350 may extend entirely around sleeve 332 or may be enclosed by one or more rib projections (not shown) that cause liquid in inlet passageway 350 to flow through passage 350 and passage 352 into the interior of sleeve 332. Outlet passages 354, 356 also exist between sleeve 332 and liquid chamber 304. Outlet passageway 356 may extend entirely around sleeve 332 or may be enclosed by one or more rib projections (not shown) that cause liquid to flow through passageways 354, 356 from the interior of sleeve 332. Passageway 354 and passageway 350 may be connected to form a common passageway.

Housing 302 includes a liquid outlet opening 308 and valve seat 366. Connected to housing 302 is lower housing 370. Housing 302 includes projecting member 309 that engages with projecting member 367 of lower housing 370 to form a snap-fit connection. Optionally, lower housing 370 may be connected to housing 302 by any means such as, for example, a threaded connection, a press-fit connection, a welded connection, an adhesive connection or the like. Lower housing 370 has an interior cavity 373. Lower housing 370 also includes a first annular projection 365 that forms an air inlet 336. In addition, lower housing 370 includes a floor 371. A tapered section 372 extends from floor 371 to annular outlet 374.

Located within cavity 373 is an insert 390. Insert 390 may be made of one or more components. Insert 390 includes an interior cavity 396 formed by annular member 392. Interior cavity 396 retains one-way outlet valve 364 and biasing member 368. Interior cavity 396 is also the mixing chamber. One-way outlet valve 364 seals against valve seat 366. One-way outlet valve 364 may be any type of one-way valve such as, for example, a ball and spring valve, a poppet valve, a flap valve, an umbrella valve, a slit valve or the like.

Insert 390 includes an opening 394 to allow liquid and air to flow down and through foaming media 375 secured therein. Foaming media 375 may be one or more screens, porous members, baffles, sponges, foaming cartridges, a combination thereof or the like. Foaming media 375 may be an integral part of insert 390 or may be a separate part.

In addition, although the pump 301 has been described as being made of selected sub-parts, pump 301, as well as the other embodiments of pumps disclosed herein, may be made from more sub-parts or fewer sub-parts.

During operation, as piston 340 of pump 301 moves from a discharged position to a charged position or primed state, liquid flows in through liquid inlets 324, past one-way inlet valve 326 into liquid chamber 304 and through passages 350, 352 and into the interior of sleeve 332 (which also forms a portion of the liquid chamber 304).

Movement of piston 340 from the charged position to the discharged position causes fluid to flow out of the liquid chamber 304 (including the center of the sleeve 332 through passages 354, 356 past liquid outlet valve 364 into mixing chamber 396. Simultaneously, the volume of air chamber 343 is reduced and air flows out of air outlet 336 into cavity 373, up around annular projection 392 and mixes with the liquid in mixing chamber 396. The air and liquid mixture is forced through opening 394 and through foam media 375 to create a rich foam. The rich foam travels through tapered section 372 where it accelerates due to the reduced volume and exits foam pump 301 through outlet 374.

The air compressors and liquid pumps described herein may include biasing members to return them to a charged or primed state. In some embodiments, a biasing member in the actuator mechanism returns the air compressor and/or liquid pump to a first state. Still yet, if the air compressor and/or liquid pump are electrically operated, they may be moved to the first state electronically.

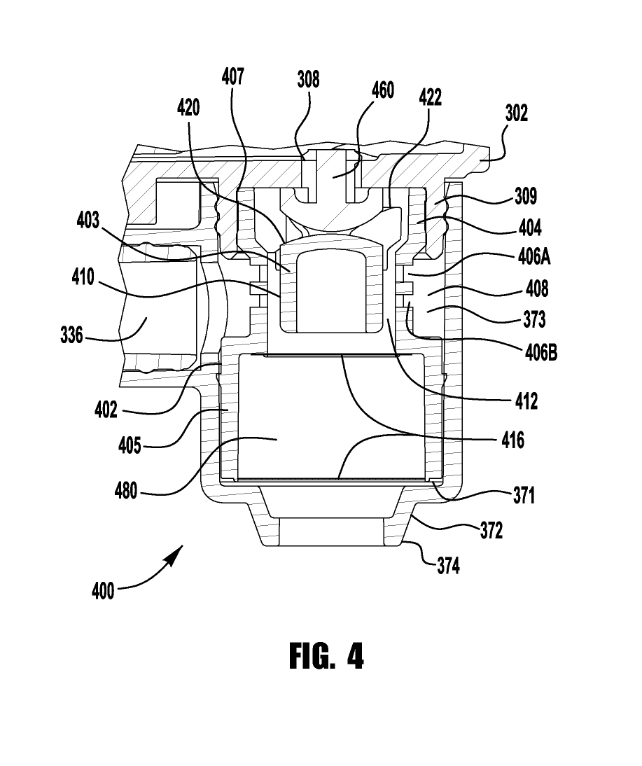

FIG. 4 is an enlarged cross-sectional view of an exemplary foam cartridge 400 located in the lower housing 370 of liquid pump 301. Foam cartridge 400 provides an enhanced mixing of air and liquid and is particularly useful for hard to foam liquids, such as liquids containing alcohol. Housing 302 is substantially the same as shown and described with respect to FIG. 3, however housing has been modified to accept liquid outlet valve 460. Foam cartridge 400 fits within cavity 373. Foam cartridge 400 has an outer cylindrical housing 402. In this exemplary embodiment, outer cylindrical housing 402 has an upper portion 404 and a lower portion 405. Lower portion 405 seals against lower pump housing 309. Upper portion 404 includes one or more projections 407 for connecting to annular projecting member 309 of upper pump housing 302. In some embodiments the upper portion 404 of foam cartridge 400 fits within projecting member 309, and in some embodiments seals against projecting member 309. In some embodiments, the upper portion includes a first portion that has a first diameter and a second portion that has a second diameter, giving the foam cartridge and hour-glass shape as illustrated in FIG. 4. In other embodiments, upper portion 404 has a single continuous diameter.

Foam cartridge 400 includes a cylindrical interior member 403. Cylindrical interior member has a closed end 420. In some embodiments, closed end 420 has a dome shape. In addition, one or more curved ribs 422 are located on the dome shaped closed end 420. A plurality of liquid passages 424 allow liquid to pass from above the dome shaped closed end to mixing passage 412. In some embodiments, the curved ribs 422 cause the liquid to rotate as it passes through the liquid passages 424. In some embodiments, the curved ribs cause turbulence in the liquid as it flows through liquid passages 424 allowing for the air to mix more uniformly with the liquid.

Located between the inner wall of the upper portion 404 of foam cartridge 400 and the exterior of the cylindrical interior member 403 is mixing passage 412. In addition, located between the lower housing 370 and the upper portion 404 of foam cartridge 400 is an air chamber 408. One or more apertures 406A, 406B located through the upper portion 404 of the foam cartridge 400 places air chamber 408 in fluid communication with mixing passage 412.

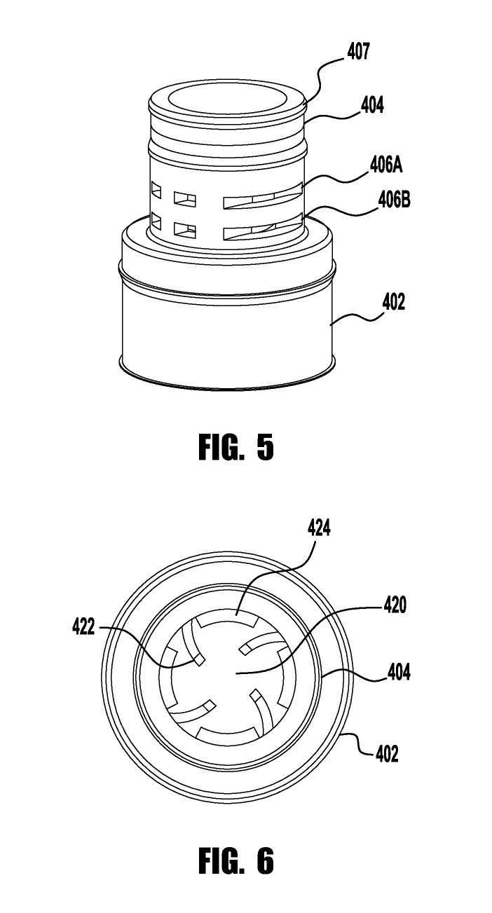

As best illustrated with respect to FIG. 5, apertures 406A, 406B may be tapered inward toward mixing passage 412. In addition, apertures 406A, 406B may be offset along the vertical axis from one another. Multiple apertures provide for enhanced mixing of liquid and air in mixing passage 412.

Mixing passage 412 opens into mixing area 480. The cross-sectional area of mixing area 480 is greater than the cross-sectional area of mixing passage 412. In some embodiments, the cross-sectional area of the mixing area 480 is greater than about five times the cross-sectional area of the mixing passage 412. In some embodiments, the cross-sectional area of the mixing area 480 is greater than about ten times the cross-sectional area of the mixing passage 412. In some embodiments, the cross-sectional area of the mixing area 480 is between about three and ten times the cross-sectional area of the mixing passage 412. In some embodiments, the cross-sectional area of the mixing area 480 is between about five and seven times the cross-sectional area of the mixing passage 412. Preferably foam cartridge 400 is made of a single unitary piece; however, foam cartridge 400 may be made of several pieces.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants' general inventive concept.

We claim:

1. A foam cartridge for a foam pump comprising:
a housing;
the housing having an upper cylindrical portion and a lower cylindrical portion;
one or more air passageways through the upper cylindrical portion; and
an interior cylindrical member having a closed top;
the interior cylindrical member is located at least partially within the upper cylindrical portion of the housing;
one or more mixing passages located between the interior cylindrical member and the upper cylindrical portion of the housing; and
one or more mix media located at least partially within the lower cylindrical portion of the housing.

2. The foam cartridge of claim 1 further comprising one or more curved ribs located on the closed portion of the interior cylindrical member.

3. The foam cartridge of claim 1 wherein the upper cylindrical portion has a smaller outside diameter than the lower cylindrical portion.

4. The foam cartridge of claim 1 wherein at least two of the air inlet passages are offset along the vertical axis.

5. The foam cartridge of claim Error! Reference source not found, wherein at least one air passage has an inward tapered shape.

6. The foam cartridge of claim 1 wherein at least a portion of the lower cylindrical portion has a diameter that is greater than at least a portion of a diameter of the upper cylindrical.

7. The foam cartridge of claim 1 wherein the interior of the lower cylindrical portion has a cross-sectional area that is greater than about five times the cross-sectional area of the mixing passage

8. The foam cartridge of claim 1 further comprising an air compressor and a liquid pump, wherein the air compressor is in fluid communication with the one or more air passages and the liquid pump is in fluid communication with the one or more liquid passages.

9. The foam cartridge of claim 8 further comprising a container for holding a foamable liquid connected to the liquid pump.

10. A refill unit comprising:
a container;
a foamable liquid in the container;
a liquid pump in fluid communication with the container;
an air inlet for receiving pressurized air;
a foam cartridge located downstream of the liquid pump and in fluid communication with the air inlet;
the foam cartridge having
a cylindrical outer housing;
a cylindrical interior member;
the cylindrical interior member having a closed upper portion;
one or more liquid inlets located proximate the closed upper portion to allow liquid to flow around the cylindrical interior member;
a mixing passage located between the cylindrical outer housing and the cylindrical interior member; and
one or more air passages through the cylindrical outer housing into the mixing passage.

11. The refill unit of claim 10 wherein the closed portion of the cylindrical interior member has a dome shape.

12. The refill unit of claim 11 further comprising one or more curved ribs located on the dome shaped closed portion of the interior cylindrical member.

13. The refill unit of claim 10 wherein the cylindrical outer housing has an upper cylindrical portion and a lower cylindrical portion and the upper cylindrical portion has a smaller outside diameter than the lower cylindrical portion.

14. The refill unit of claim 10 wherein at least two of the air passages are offset along a vertical axis.

15. The refill unit of claim 10 wherein the mixing passage opens to a mixing area having cross-sectional area that is greater than about five times the cross-sectional area of the mixing passage.

16. The refill unit of claim 10 wherein at least one air passage has an inward tapered shape.

17. The refill unit of claim 15 further comprising one or more screens located in the mixing area.

18. A refill unit comprising:
a container of foamable liquid;
an outlet nozzle;
a liquid pump having a liquid outlet;
an air inlet for receiving pressurized air;
a foam cartridge;
the foam cartridge having a cylindrical outer housing and a cylindrical interior member;
a mixing passage located at least partially between the cylindrical outer housing and the cylindrical interior member;
an air chamber about the exterior of the cylindrical outer housing;
one or more air passages extending through the cylindrical outer housing to the mixing passage between the cylindrical outer housing and the cylindrical interior member;
wherein liquid and air meet in the mixing passage; and
wherein the mixing passage opens to a mixing area having a cross-sectional area that is greater than the cross-sectional area of the mixing passage.

19. The refill unit of claim 18 further comprising a dome shape on the upper portion of the cylindrical interior member.

20. The refill unit of claim 18 wherein the cylindrical outer housing has an upper portion and a lower portion and wherein the diameter of the upper portion is less than the diameter of the lower portion.

21. The refill unit of claim 20 further comprising an air compressor in fluid communication with the air inlet.
